(19) United States
(12) Patent Application Publication
(10) Pub. No.: US 2021/0154767 A1
(43) Pub. Date: May 27, 2021

(54) LASER LIGHT EMISSION HEAD AND LASER PROCESSING APPARATUS USING SAME

(71) Applicant: Panasonic Intellectual Property Management Co., Ltd., Osaka (JP)

(72) Inventor: Tomoyuki KAGEYAMA, Osaka (JP)

(21) Appl. No.: 17/167,220

(22) Filed: Feb. 4, 2021

Related U.S. Application Data
(63) Continuation of application No. PCT/JP2019/005305, filed on Feb. 14, 2019.

(30) Foreign Application Priority Data
Aug. 24, 2018 (JP) 2018-157477

(51) Int. Cl. B23K 26/16; B23K 26/12; B23K 26/08

(52) U.S. Cl. CPC B23K 26/16; B23K 2103/54; B23K 26/0869; B23K 26/123

(57) ABSTRACT

A laser light emission head includes a laser light shaping unit laser light shaping unit having a first housing configured such that laser light enters an upper portion of the first housing and optical components configured to shape the laser light into a desired shape are arranged in the first housing and a glass holder to which multiple protection glasses are attached with a predetermined spacing. Moreover, the laser light emission head includes a cleaning unit having a second housing in which a cleaning mechanism for cleaning the protection glasses attached to the glass holder is arranged. The glass holder is configured movably between the first housing and the second housing.

### CROSS-REFERENCE TO RELATED APPLICATIONS

This is a continuation of International Application No. PCT/JP2019/005305 filed on Feb. 14, 2019, which claims priority to Japanese Patent Application No. 2018-157477 filed on Aug. 24, 2018. The entire disclosures of these applications are incorporated by reference herein.

### TECHNICAL FIELD

The present disclosure relates to a laser light emission head and a laser processing apparatus using the laser light emission head. Particularly, the present disclosure relates to a laser light emission head including a mechanism for cleaning protection glasses provided at the laser light emission head.

### BACKGROUND

Typically, a laser processing apparatus configured such that laser light generated by a laser oscillator is emitted toward a workpiece through a laser light emission head having various optical components to process the workpiece has been known.

For protecting the optical components arranged in the laser light emission head from, e.g., fume or spatter caused in laser processing, protection glasses are provided in the vicinity of a laser light outlet in the laser light emission head. Normally, the multiple protection glasses are arranged with a predetermined spacing in a laser light optical axis direction. For preventing, e.g., oxidation of a processed portion in the laser processing, the processing is performed while shield gas is being sprayed onto the workpiece. Such shield gas reduces adherence of the fume etc. to the protection glasses.

However, the protection glass arranged at a position closest to the workpiece shows an increase in surface contamination as the number of workpieces to be processed or processing time proceeds, and accordingly, reduction in a laser light transmittance is caused. Due to such transmittance reduction, the output of the laser light with which the workpiece is irradiated is reduced. In an extreme case, the protection glass might reflect the laser light into the laser light emission head, and such light might damage the above-described optical components.

For this reason, the protection glass is replaced on a regular basis. Japanese Unexamined Patent Publication No. 11-245072 discloses a configuration in which a slit is provided at a lens barrel of a laser light emission head and a protection glass is inserted through the slit to improve replaceability.

For evaluating reduction in the transmittance of the protection glass due to surface contamination, Japanese Unexamined Patent Publication No. 2016-196029 discloses a configuration in which a probe light generator is attached to a lend barrel of a laser light emission head, probe light enters a protection glass from a direction different from that of laser light for processing, and transmitted light is received by a light detection element. With this configuration, the transmittance of the protection glass, i.e., the degree of contamination, is evaluated.

### SUMMARY

However, upon replacement of the protection glass, operation of the laser processing apparatus needs to be stopped for operation safety. This leads to an increase in apparatus downtime and productivity degradation.

The present disclosure has been made in view of the above-described point, and an object thereof is to provide a laser light emission head configured so that the process of replacing a protection glass can be omitted and a laser processing apparatus using the laser light emission head.

For accomplishing the above-described object, the laser light emission head according to the present disclosure includes a laser light shaping unit having a first housing configured such that laser light enters an upper portion of the first housing and an optical component configured to shape the laser light into a desired shape is arranged in the first housing, a glass holder to which multiple protection glasses are attached with a predetermined spacing, and a cleaning unit having a second housing in which a cleaning mechanism for cleaning the protection glasses attached to the glass holder is arranged. The glass holder is configured movably between the first housing and the second housing.

According to this configuration, a surface of the protection glass can be cleaned without the need for detaching the protection glass from the laser light emission head. Moreover, the process of replacing the protection glass can be omitted, and therefore, maintenance of the laser light emission head is facilitated.

The laser processing apparatus according to the present disclosure at least includes a laser oscillator configured to emit laser light and the above-described laser light emission head configured to receive the laser light to emit the laser light toward a workpiece.

According to this configuration, apparatus downtime and an operation cost can be reduced. Moreover, operation can be performed with fluctuation in the output of the laser light being suppressed, and therefore, favorable processing quality can be maintained.

According to the laser light emission head of the present disclosure, the process of replacing the protection glass can be omitted, and therefore, maintenance of the laser light emission head is facilitated. Moreover, according to the laser processing apparatus of the present disclosure, operation can be performed with fluctuation in the output of the laser light being suppressed, and therefore, favorable processing quality can be maintained.

### BRIEF DESCRIPTION OF THE DRAWINGS

FIG. 1 is a view illustrating a configuration of a laser processing apparatus according to a first embodiment of the present disclosure.

FIG. 2 is a schematic sectional view of a laser light emission head along an II-II line of FIG. 1.

FIG. 3 is a schematic sectional view of the laser light emission head along an line of FIG. 2.

FIG. 4 is a schematic view illustrating an internal configuration of a cleaning unit.

FIGS. 5A and 5B are schematic views illustrating the state of rotary movement of a glass holder in the laser light emission head.

FIG. 6 is a schematic view illustrating an internal configuration of a cleaning unit according to a first variation.

FIG. 7 is a schematic sectional view of a laser light emission head according to a second variation.

FIG. 8 is a schematic view illustrating an internal configuration of a cleaning unit according to a second embodiment of the present disclosure.

FIG. 9 is a schematic sectional view of a laser light emission head according to a third embodiment of the present disclosure.

FIG. 10 is a schematic view illustrating an internal configuration of an evaluation unit.

### DETAILED DESCRIPTION

Hereinafter, embodiments of the present disclosure will be described in detail based on the drawings. Description of the preferred embodiments below will be made merely as examples in nature, and is not intended to limit the present disclosure and application and use thereof.

### First Embodiment

[Configuration of Laser Processing Apparatus]

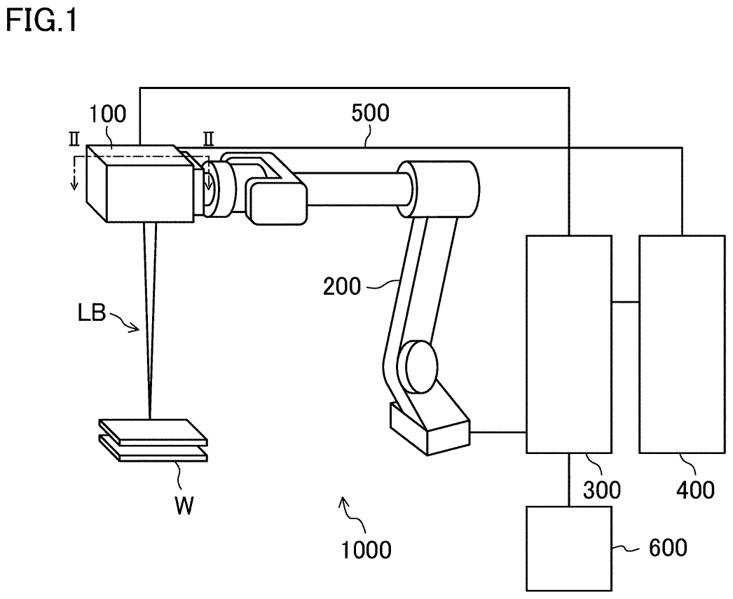

FIG. 1 illustrates a configuration of a laser processing apparatus 1000 according to the present embodiment, and the laser processing apparatus 1000 includes a laser light emission head 100, a manipulator 200, a control apparatus 300, a laser oscillator 400, an optical fiber 500, and a display apparatus 600. The laser processing apparatus 1000 is used for performing, e.g., cutting, welding, or drilling of a workpiece W. Note that for the sake of convenience in description, the shape of the laser light emission head 100 illustrated in FIG. 1 is illustrated in a simple shape.

The laser light emission head 100 receives laser light LB emitted from the optical fiber 500 to irradiate the workpiece W with the laser light LB. The laser light emission head 100 is attached to a tip end of the manipulator 200, and the manipulator 200 moves the laser light emission head 100.

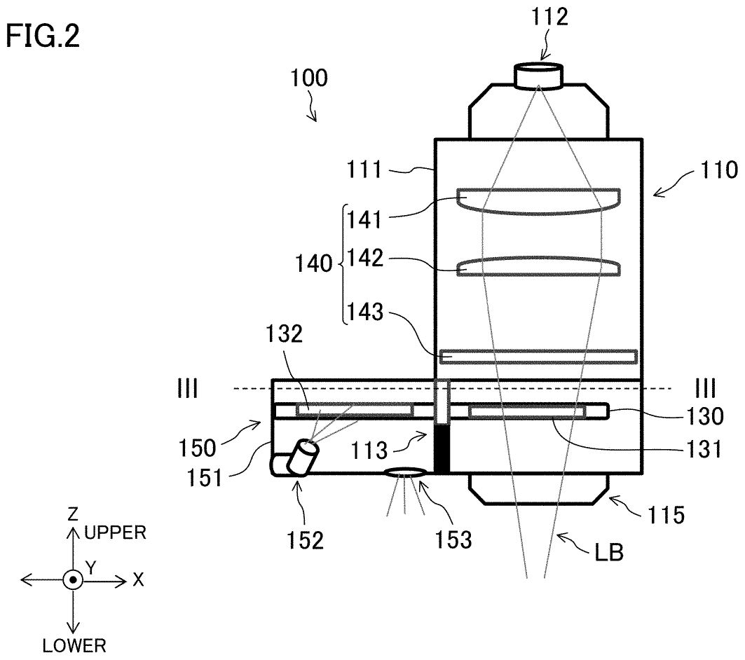

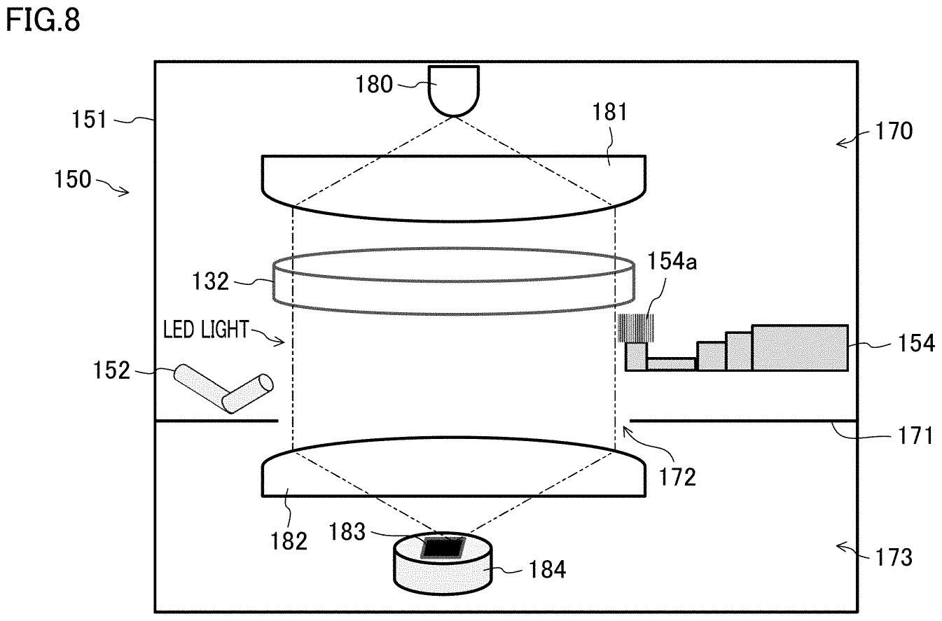

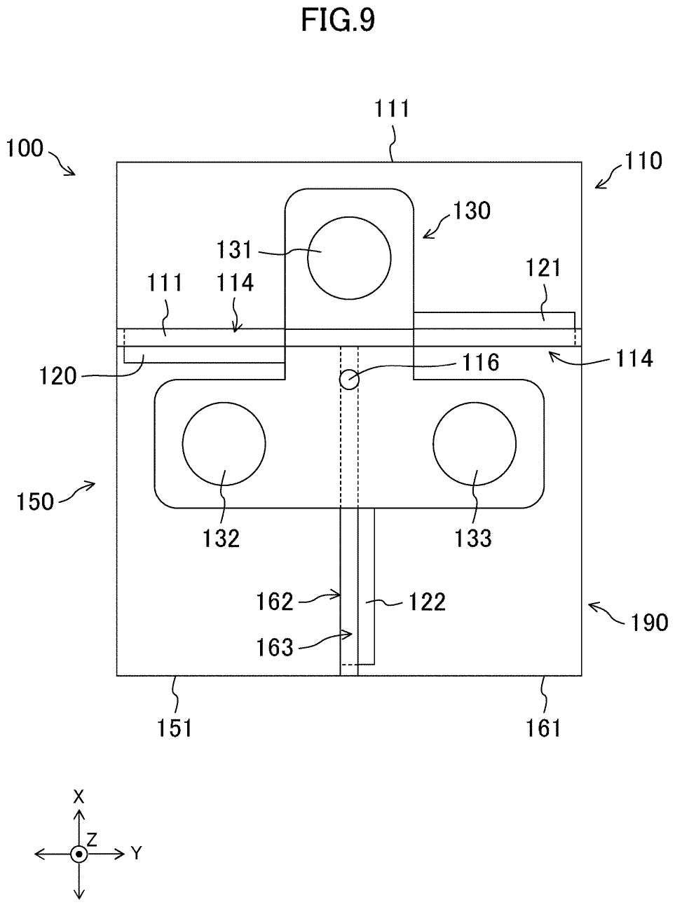

The control apparatus 300 controls operation of the laser light emission head 100, operation of the manipulator 200, and laser oscillation of the laser oscillator 400. Moreover, the control apparatus 300 is configured to control operation of a glass holder 130 and drive of an LED light source 180 (see FIG. 8) as described later, thereby receiving a light reception signal from a light receiving element 183 (see FIG. 8) to evaluate the transmittances of protection glasses 131 to 133 (see FIGS. 2 and 9).

The laser oscillator 400 generates the laser light LB to output the laser light LB to the optical fiber 500. The optical fiber 500 transmits, to the laser light emission head 100, the laser light LB emitted from the laser oscillator 400. The display apparatus 600 is connected to the control apparatus 300, and displays, e.g., various processing conditions during laser processing. Moreover, the display apparatus 600 displays the transmittances of the protection glasses 131 to 133 as described later. With this configuration, the laser processing apparatus 1000 operates the laser light emission head 100 and the manipulator 200 to irradiate the workpiece W with the laser light LB emitted from the laser oscillator 400 in a desired route. Note that the display apparatus 600 may be incorporated in the control apparatus 300.

An operation device (not shown) for inputting the processing conditions, such as a keyboard, may be connected to the control apparatus 300. In a case where the operation device is a touch panel, the touch panel may be incorporated in the control apparatus 300.

[Internal Configuration of Laser Light Emission Head]

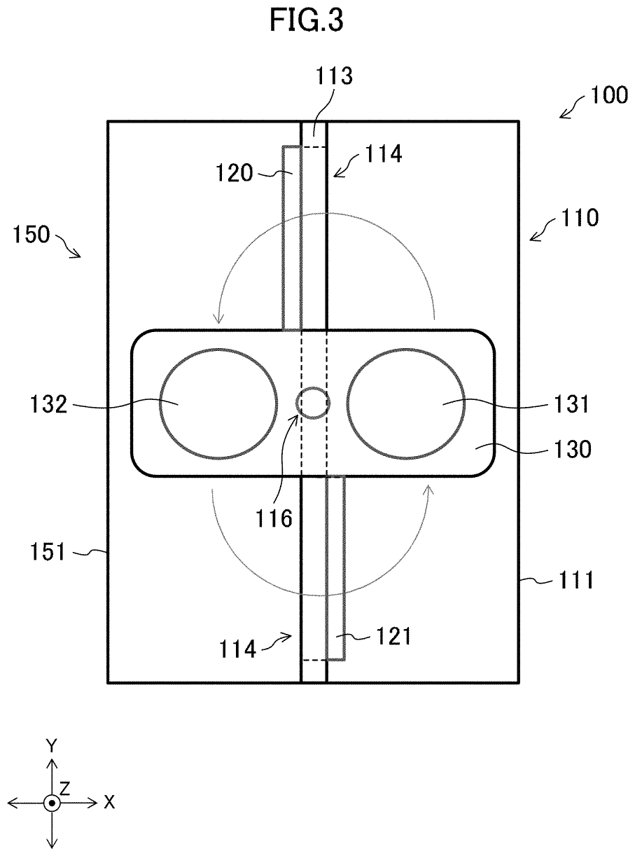

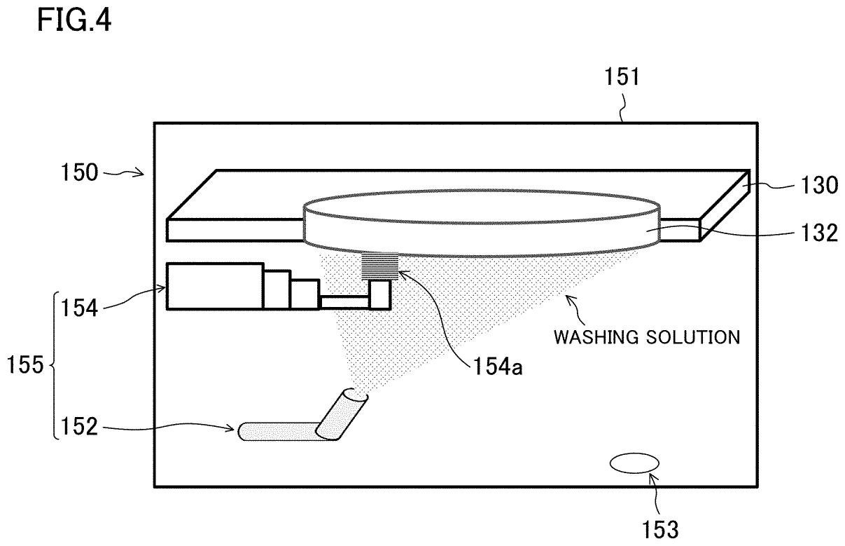

FIG. 2 illustrates a schematic sectional view of the laser light emission head along an II-II line of FIG. 1, and FIG. 3 illustrates a schematic sectional view of the laser light emission head along an line of FIG. 2. Moreover, FIG. 4 illustrates a schematic view of an internal configuration of a cleaning unit. Note that for the sake of convenience in description, part of the glass holder 130 is omitted in FIG. 4. In description below, the direction of emitting the laser light LB will be sometimes referred to as a Z-direction, the direction of arraying a laser light shaping unit 110 and the cleaning unit 150 will be sometimes referred to as an X-direction, and a direction perpendicular to the X-direction and the Z-direction will be sometimes referred to as a Y-direction. In the Z-direction, a side on which the laser light LB enters the laser light shaping unit 110 will be sometimes referred to as an upper side, and a side opposite thereto, i.e., a side on which the laser light LB is emitted, will be sometimes referred to as a lower side.

The laser light emission head 100 has the laser light shaping unit 110 and the cleaning unit 150. The laser light shaping unit 110 has a first housing 111, and the cleaning unit 150 has a second housing 151. The first and second housings 111, 151 share a first partition wall 113, and are provided in contact with each other. The first partition wall 113 stands along the Z-direction as an optical axis direction of the laser light LB. A first slit 114 causing the first and second housings 111, 151 to communicate with each other is formed at the first partition wall 113. Further, the laser light emission head 100 has the glass holder 130 to which two protection glasses 131, 132 are attached with a predetermined spacing. A rotary shaft 116 penetrating the first partition wall 113 in an axial direction is inserted into the glass holder 130, and the glass holder 130 is integrally rotatably coupled to the rotary shaft 116. Moreover, the rotary shaft 116 is provided at the first partition wall 113 to cross the first slit 114 in the axial direction, and the glass holder 130 is configured rotatably about the rotary shaft 116 to pass through the first slit 114. First and second opening/closing doors 120, 121 are, in contact with the glass holder 130, attached to the first partition wall 113 to close the first slit 114. The first opening/closing door 120 and the second opening/closing door 121 are each attached to opposing surfaces of the first partition wall 113. Rotary motion of the glass holder 130 and movement of the first and second opening/closing doors 120, 121 in association with such rotary motion will be described in detail later.

A drive mechanism (not shown) configured to rotatably drive the rotary shaft 116 is attached to the laser light emission head 100. This drive mechanism is configured to rotate, according to a control signal from the control apparatus 300, the rotary shaft 116 and the glass holder 130 coupled thereto counterclockwise as viewed from above.

As illustrated in FIG. 2, the glass holder 130 is normally fixed to a predetermined position in the laser light emission head 100 such that one of two protection glasses 131, 132 attached to the glass holder 130 itself is arranged in the first housing 111 of the laser light shaping unit 110 and the other one of two protection glasses 131, 132 is arranged in the second housing 151 of the cleaning unit 150. The protection glass 131 arranged in the first housing 111 of the laser light shaping unit 110 is arranged on the optical axis of the laser light LB.

The laser light shaping unit 110 is an optical unit configured such that in the first housing 111 having a laser light inlet 112 on the upper side and a laser light outlet 115 on the lower side, optical components 140 such as a collimate lens 141, a condensing lens 142, and a protection glass 143 are arranged in a predetermined position relationship. The laser light LB having entered the laser light shaping unit 110 from the laser light inlet 112 through the optical fiber 500 is converted into a collimated light beam by the collimate lens 141, and thereafter, is shrunk with a predetermined magnification by the condensing lens 142. Then, the laser light LB penetrates each of the protection glasses 143, 131, and is emitted from the laser light outlet 115 to the workpiece W. That is, the optical components 140 shape the laser light LB into a desired shape. Note that each of the collimate lens 141 and the condensing lens 142 may include multiple lenses.

The optical components 140 in the first housing 111 may include, in addition to the above-described components, a transparent plate or a partial reflection mirror arranged inclined to a predetermined direction with respect to the optical axis of the laser light LB, for example. However, illustration and description of these components will be omitted. Similarly, there is a case where a drive mechanism configured to drive some of the optical components 140 is attached to the first housing 111, but illustration and description of these components will be omitted. Further, the laser light shaping unit 110 has a shield gas supply port and a shield gas pipe for spraying, as shield gas, inert gas such as argon from the vicinity of the laser light outlet 115 to the workpiece W, but illustration and description of these components will be omitted.

The cleaning unit 150 has the second housing 151, a washing solution supply nozzle 152 in the second housing 151, a washing solution supply pipe (not shown) connected to the washing solution supply nozzle 152, and a brushing mechanism 154 having a tip end to which a brush 154a is attached. A drain port 153 for discharging a washing solution to the outside is provided at the second housing 151. A not-shown drain pipe is connected to the drain port 153.

The washing solution supplied through the washing solution supply pipe is discharged from the washing solution supply nozzle 152, and is sprayed onto a lower surface of the protection glass 132 arranged in the cleaning unit 150. The brushing mechanism 154 is driven by a not-shown drive mechanism, and accordingly, the brush 154a contacts the protection glass 132 to which the washing solution adheres. The brush 154a moves while pressing the protection glass 132 with a predetermined pressure, thereby removing contamination adhering to the surface of the protection glass 132, such as spatter or fume, together with the washing solution. After washing, the washing solution is discharged to the outside of the second housing 151 through the drain port 153. Note that in description below, the washing solution supply nozzle 152 and the washing solution supply pipe will be sometimes collectively referred to as a washing solution supply mechanism. Moreover, the washing solution supply mechanism and the brushing mechanism 154 will be sometimes collectively referred to as a cleaning mechanism 155.

Note that a volatile washing solution such as an alcohol-based solution is used in the present embodiment, and therefore, it is not necessary to perform particular drying process after washing. However, in the case of using a water-soluble washing solution, a mechanism configured to dry the surface of the protection glass 132, such as a dry air spraying mechanism, is preferably arranged in the second housing 151.

[Cleaning of Protection Glass]

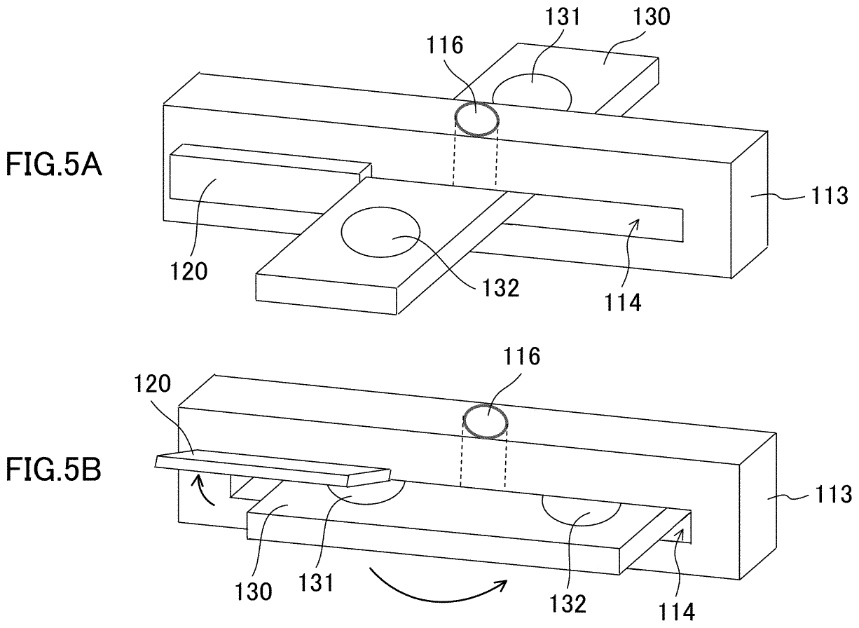

FIGS. 5A and 5B schematically illustrate the state of rotary movement of the glass holder in the laser light emission head. Note that for the sake of convenience in description, the second opening/closing door 121 is not shown in the figure.

The first and second opening/closing doors 120, 121 are, on upper sides thereof, attached to the first partition wall 113 through not-shown hinges such as hinge braces, and are configured rotatably in an XZ plane about the hinges as pivot points. Moreover, the first opening/closing door 120 is arranged in the cleaning unit 150, and the second opening/closing door 121 is arranged in the laser light shaping unit 110.

As illustrated in FIG. 5A, in an initial state, a longitudinal direction of the glass holder 130 is positioned to cross a longitudinal direction of the first slit 114, the protection glass 131 is arranged in the first housing 111, and the protection glass 132 is arranged in the second housing 151. Moreover, the first and second opening/closing doors 120, 121 contact the first partition wall 113 to close the first slit 114.

When the rotary shaft 116 and the glass holder 130 coupled thereto are rotated 90° in a counterclockwise direction as viewed from above, the glass holder 130 having passed through the first slit 114 pushes the first opening/closing door 120 as illustrated in FIG. 5B, and accordingly, the first opening/closing door 120 rotates about the hinge as the pivot point and is lifted up. Similarly, the second opening/closing door 121 is also pushed and lifted up by the glass holder 130. With this configuration, the glass holder 130 can rotatably move about the rotary shaft 116 as a spindle to pass through the first slit 114.

When the rotary shaft 116 and the glass holder 130 are further rotated 90° in the same direction, the glass holder 130 is at the same position as that illustrated in FIG. 5A. Note that the positions of the protection glasses 131, 132 are switched to each other, and therefore, the protection glass 132 is arranged in the first housing 111 and the protection glass 131 is arranged in the second housing 151. When the glass holder 130 no longer pushes the first and second opening/closing doors 120, 121, each of the first and second opening/closing doors 120, 121 returns to an original position to close the first slit 114. Note that in the present embodiment, it is configured such that the rotary shaft 116 and the glass holder 130 rotate only in the counterclockwise direction. However, in a case where the direction of attaching the first and second opening/closing doors 120, 121 is reversed, it is configured such that the rotary shaft 116 and the glass holder 130 rotate only in the opposite direction, i.e., a clockwise direction. As described above, the optical components 140 are arranged in the first housing 111, and the laser light LB penetrates these optical components 140 or is reflected on these optical components 140. In some cases, part of the laser light LB is diffusely reflected such that a travelling direction thereof is changed. When the diffusely-reflected light enters the cleaning unit 150 through the first slit 114, such light might damage various components in the cleaning unit 150.

The first and second opening/closing doors 120, 121 are provided to close the first slit 114, and therefore, leakage of the laser light LB from the laser light shaping unit 110 to the cleaning unit 150 is prevented. Note that a predetermined clearance may be, to such an extent that no leakage of the laser light LB occurs, provided between each of the first and second opening/closing doors 120, 121 and the first partition wall 113.

As described above, in the laser light shaping unit 110 illustrated in FIG. 2, the protection glass 131 closest to the laser light outlet 115 tends to show a decreased transmittance due to surface contamination caused as the number of workpieces W to be processed increases or processing time proceeds. For this reason, the protection glass 131 typically needs to be replaced on a regular basis.

On the other hand, the laser light emission head 100 having the above-described configuration is used so that the protection glass 131 or the protection glass 132 whose surface has been contaminated can be cleaned without the need for detaching such a protection glass from the laser light emission head 100 and the laser processing and such cleaning can be performed in parallel. Such a procedure will be described below.

Once a predetermined number of workpieces W are processed by the laser processing apparatus 1000, the rotary shaft 116 and the glass holder 130 coupled thereto are rotated 180° such that the position of the protection glass 131 arranged in the first housing 111 and the position of the protection glass 132 arranged in the second housing 151 are switched to each other.

Thereafter, while the workpiece W is being processed using the laser light LB having penetrated the protection glass 132, the surface of the protection glass 131 is cleaned by the cleaning mechanism 155 in the cleaning unit 150. Note that the protection glass 131 may be cleaned during such stand-by time that the workpiece W is not processed.

By repetition of such a procedure, the protection glasses 131, 132 can be cleaned without the need for detaching the protection glasses 131, 132 from the laser light emission head 100. Note that based on, e.g., experiment performed in advance, the timing of switching the protection glasses 131, 132 to each other is set. Moreover, subsequent laser processing is preferably performed after the output of the laser light LB after switching of the protection glasses 131, 132 has been checked. Note that before and after switching of the cleaned protection glasses 131, 132, if a certain amount of output fluctuation data on the laser light LB or more is aggregated and a result thereof is within an acceptable output fluctuation range, checking of the output of the laser light LB after switching of the protection glasses 131, 132 can be omitted. [Advantageous Effects etc.]

As described above, the laser light emission head 100 according to the present embodiment includes the laser light shaping unit 110 having the first housing 111 configured such that the laser light LB enters an upper portion of the first housing 111 and the collimate lens 141, the condensing lens 142, and the protection glass 143 as the optical components 140 configured to shape the laser light LB into the desired shape are arranged in the first housing 111, and the glass holder 130 to which the multiple protection glasses 131, 132 are attached with the predetermined spacing.

The laser light emission head 100 further includes the cleaning unit 150 having the second housing 151 in which the cleaning mechanism 155 configured to clean the protection glasses 131, 132 attached to the glass holder 130 is arranged. The glass holder 130 is configured movably between the first housing 111 and the second housing 151.

The laser light emission head 100 is configured as described above so that, e.g., in a case where the surface of the protection glass 131 is contaminated by the fume etc., the glass holder 130 can be moved to arrange the protection glass 131 in the cleaning unit 150 and the protection glass 131 can be cleaned. With this configuration, the laser light emission head 100 can be used without the need for detaching the protection glass 131 from the laser light emission head 100. Moreover, in a case where the transmittances of the protection glasses 131, 132 decrease in association with continuous operation, the surfaces are cleaned such that the transmittances approach original values, and therefore, reduction in the output of the laser light LB can be suppressed. Further, the process of replacing the protection glasses 131, 132 can be omitted, and therefore, maintenance of the laser light emission head 100 is facilitated.

The second housing 151 and the first housing 111 share the first partition wall 113, and the first slit 114 causing the laser light shaping unit 110 and the cleaning unit 150 to communicate with each other is provided at the first partition wall 113. The glass holder 130 is configured movably between the first housing 111 and the second housing 151 through the first slit 114.

The laser light emission head 100 is configured as described above so that an open area between the first housing 111 and the second housing 151 can be reduced in size. Thus, entrance of, e.g., the diffusely-reflected light, which is caused in the first housing 111, of the laser light LB into the second housing 151 can be reduced, and damage of each component forming the cleaning mechanism 155 can be prevented, for example.

In the present embodiment, the glass holder 130 is integrally rotatably coupled to the rotary shaft 116 provided at the first partition wall 113. The glass holder 130 is configured to rotate a predetermined angle, specifically 180°, thereby moving the protection glass 131 arranged in the laser light shaping unit 110 into the cleaning unit 150 and moving the protection glass 132 arranged in the cleaning unit 150 into the laser light shaping unit 110.

With this configuration, the process of switching the protection glasses 131, 132 to each other is simplified, and positioning of the protection glass 131, 132 in the laser light shaping unit 110 is facilitated.

The cleaning mechanism 155 includes the washing solution supply mechanism having the washing solution supply nozzle 152 for applying the washing solution to the surface of the protection glass 131 or the protection glass 132, and the brushing mechanism 154 for removing contamination on the surface of the protection glass 131, 132 to which the washing solution adheres.

The cleaning mechanism 155 is configured as described above so that even contamination strongly adhering to the surfaces of the protection glasses 131, 132 can be removed.

The laser processing apparatus 1000 according to the present embodiment includes at least the laser oscillator 400 configured to emit the laser light LB and the laser light emission head 100 configured to receive the laser light LB to emit the laser light LB toward the workpiece W.

The laser processing apparatus 1000 is configured as described above so that the process of replacing the protection glasses 131, 132 can be omitted and apparatus downtime and an operation cost can be reduced. Moreover, operation can be performed with fluctuation in the output of the laser light LB being suppressed, and therefore, favorable processing quality can be maintained.

<First Variation>

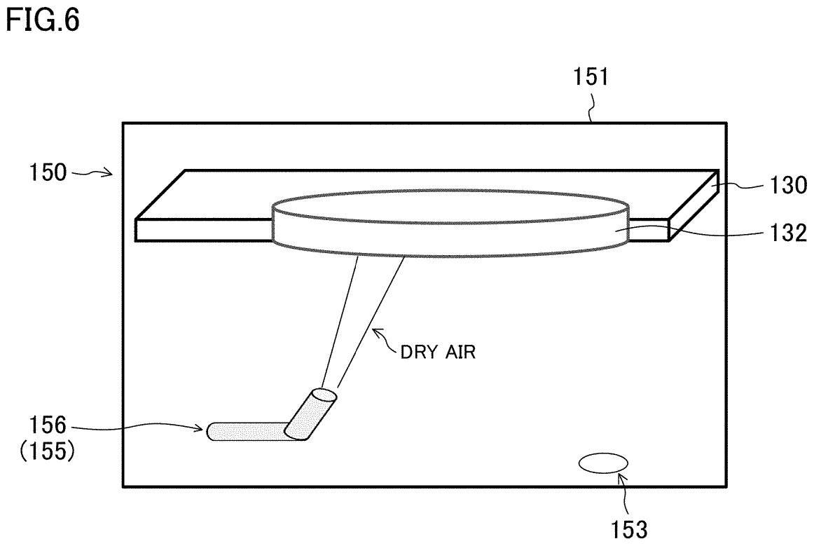

FIG. 6 illustrates a schematic view of the internal configuration of the cleaning unit according to the present variation. Note that in FIG. 6, the same reference numerals are used to represent elements similar to those of the first embodiment, and detailed description thereof will be omitted.

The configuration of the present variation illustrated in FIG. 6 is different from the configuration described in the first embodiment in the configuration of the cleaning mechanism 155. In the present variation, the cleaning mechanism 155 is configured as a gas supply mechanism configured to spray gas onto the lower surface of the protection glass 132 arranged in the second housing 151. Specifically, the gas supply mechanism includes an air nozzle 156 and a not-shown air pipe, and is configured to spray dry air onto the surface of the protection glass 132 at a predetermined flow velocity. Note that the drain port 153 functions as an exhaust port for discharging the dry air to the outside of the second housing 151.

With this configuration, contamination adhering to the surface of the protection glass 132 can be removed without the need for rubbing such a surface.

Depending on, e.g., the material of the workpiece W and the size of the spatter adhering to the surface, the surfaces of the protection glasses 131, 132 might be scratched due to rubbing for cleaning the protection glasses 131, 132. With these scratches, the output of the laser light LB penetrating the protection glasses 131, 132 might be reduced, or the laser light LB might be diffusely reflected and damage the inside of the laser light emission head 100.

On the other hand, according to the present variation, contamination can be removed without the need for rubbing the surfaces of the protection glasses 131, 132. Moreover, advantageous effects similar to those described in the first embodiment can be provided.

Note that the flow velocity and flow rate for spraying the dry air are set in advance after the degree of removal of contamination has been checked by, e.g., experiment. For preventing charging at the protection glasses 131, 132, the dry air may contain a predetermined amount of water vapor.

<Second Variation>

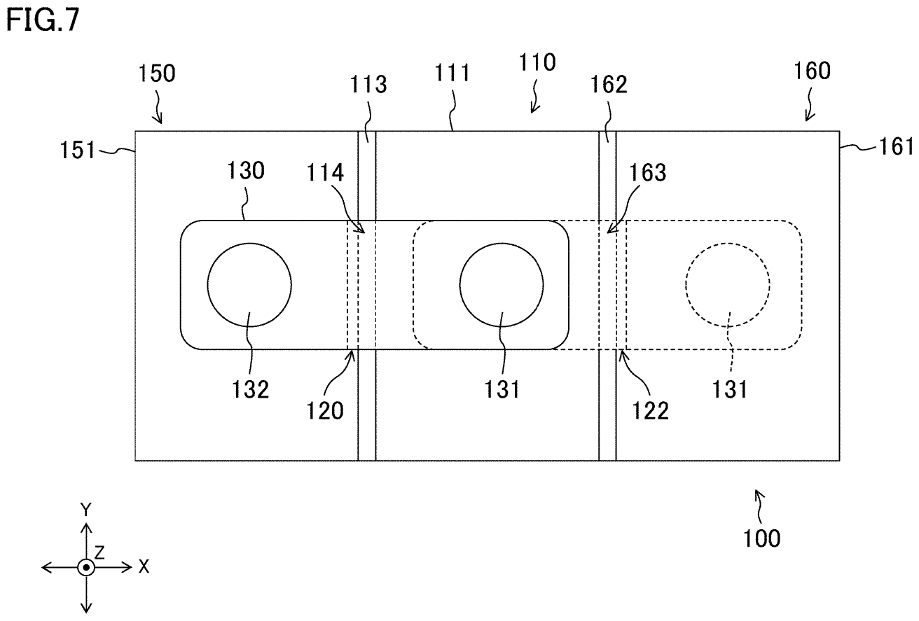

FIG. 7 illustrates a schematic sectional view of the laser light emission head according to the present variation, and corresponds to the schematic sectional view illustrated in FIG. 3. Note that in FIG. 7, the same reference numerals are used to represent elements similar to those of the first embodiment, and detailed description thereof will be omitted.

The configuration of the present variation illustrated in FIG. 7 is different from the configuration described in the first embodiment in the following points. First, a second cleaning unit 160 is arranged on the opposite side of the laser light shaping unit 110 from the cleaning unit 150. Moreover, the second cleaning unit 160 has a third housing 161 contacting the laser light shaping unit 110 and sharing a second partition wall 162. Further, a second slit 163 causing the laser light shaping unit 110 and the second cleaning unit 160 to communicate with each other is provided at the second partition wall 162, and a third opening/closing door 122 is attached to close the second slit 163. The third opening/closing door 122 is arranged in the second cleaning unit 160.

Note that in FIG. 7, arrangement in a case where each of the first and third opening/closing doors 120, 122 is closed is indicated by a dashed line. As in the first embodiment, the first and third opening/closing doors 120, 122 are rotatably moved and lifted up by movement of the glass holder 130 as described later.

Secondly, the glass holder 130 is configured linearly movably through the first slit 114 and the second slit 163. It is configured such that the glass holder 130 moves a predetermined distance toward the cleaning unit 150 to move the protection glass 131 arranged in the laser light shaping unit 110 into the cleaning unit 150. Moreover, it is configured such that the glass holder 130 moves a predetermined distance toward the second cleaning unit 160 to move the protection glass 131 arranged in the laser light shaping unit 110 into the second cleaning unit 160. Note that a drive mechanism configured to linearly move the glass holder 130 is not shown in the figure.

According to the present variation, the glass holder 130 is linearly moved, and therefore, a movement mechanism is simplified. Thus, drive control of the laser light emission head 100 is more simplified than the configuration described in the first embodiment.

Note that the second cleaning unit 160 may be an extra unit having no cleaning mechanism 155.

### Second Embodiment

FIG. 8 illustrates a schematic view of an internal configuration of a cleaning unit according to the present embodiment. Note that in FIG. 8, the same reference numerals are used to represent elements similar to those of the first embodiment, and detailed description thereof will be omitted. Moreover, a glass holder 130 is not shown in the figure.

The configuration of the present embodiment illustrated in FIG. 8 and the configuration described in the first embodiment are different from each other in that the cleaning unit 150 has an LED light source 180 and a light receiving element 183 (hereinafter sometimes referred to as a light receiving portion 183) arranged with a predetermined spacing from the LED light source 180 in an upper-lower direction.

Moreover, a second housing 151 is divided into a first sub-chamber 170 and a second sub-chamber 173 by a partition wall 171, and a cleaning mechanism 155 and a drain port (not shown) similar to those illustrated in FIG. 2 are provided in the first sub-chamber 170. In the first sub-chamber 170, the LED light source 180 and a collimate lens 181 for converting light (hereinafter referred to as LED light) emitted from the LED light source 180 into a predetermined collimated light beam are provided. An arrangement relationship between the LED light source 180 and the collimate lens 181 is set such that the LED light having penetrated the collimate lens 181 enters a protection glass 132.

In the second sub-chamber 173, a condensing lens 182, the light receiving element 183, and a holder 184 holding the light receiving element 183 are arranged. Moreover, an opening 172 allowing the LED light having penetrated the protection glass 132 to pass through the opening 172 is provided at the partition wall 171. The opening 172 is normally opened, but while the protection glass 132 is being cleaned, is covered with a not-shown shutter. This avoids a washing solution and spatter etc. removed from the protection glass 132 after cleaning from adhering to each component in the second sub-chamber 173.

The cleaning unit 150 is configured as described above so that the degree of contamination on the protection glass 132 after cleaning can be evaluated. This will be described in more detail.

After the protection glass 132 has been cleaned, the LED light is emitted from the LED light source 180. The protection glass 132 is irradiated with the LED light through the collimate lens 181. Use of the collimate lens 181 allows the LED light to enter the protection glass 132 across a wide irradiation area. The LED light having penetrated the protection glass 132 is condensed by the condensing lens 182 through the opening 172, and enters the light receiving element 183. A light reception signal based on a light reception amount is transmitted to a control apparatus 300 from the light receiving element 183, and is saved as measurement data.

In the control apparatus 300, data on measurement similarly performed for the protection glass 132 before use is saved, and the transmittance of the protection glass 132 is calculated based on the ratio of the measurement data after cleaning to the data before use. Such a transmittance is a value obtained by quantitative evaluation of the degree of contamination on the protection glass 132, and as described above, the transmittance of the protection glass 132 is influenced by the output of laser light LB emitted from a laser light emission head 100.

Thus, according to the present embodiment, the transmittance of the protection glass 132 after cleaning is evaluated so that it can be determined whether or not the protection glass 132 is usable for subsequent laser processing.

In a case where, e.g., fume or spatter merely adheres to the protection glass 132 due to laser processing, the fume or the spatter can be removed using the configuration described in the first embodiment or the first variation. When a workpiece W generates heat due to irradiation with the laser light LB, a surface of the protection glass 132 might be damaged due to exposure to a high temperature. Particularly, in a case where a state in which the surface is exposed to the high temperature is continued long in a state in which the surface is contaminated to a certain degree or the spatter in a high-temperature state adheres to the surface, damage (hereinafter referred to as “burn”) which cannot be removed by cleaning might be caused at the surface of the protection glass 132. When such burn is caused, the protection glass 132 needs to be replaced.

According to the present embodiment, the degree of contamination on the surface is evaluated from the transmittance of the protection glass 132 after cleaning, and therefore, it can be evaluated whether or not the burn is caused at the surface and whether or not such a state is acceptable.

In a case where the transmittance is equal to or less than a predetermined value after cleaning, such a state is determined as great surface burn, and the protection glass 132 is replaced and the laser light emission head 100 is brought into a usable state. Note that in a case where the transmittance does not reach a reference value after cleaning has been performed once, if the transmittance reaches the reference value after cleaning has been performed multiple times, the protection glass 132 may be used as it is.

### Third Embodiment

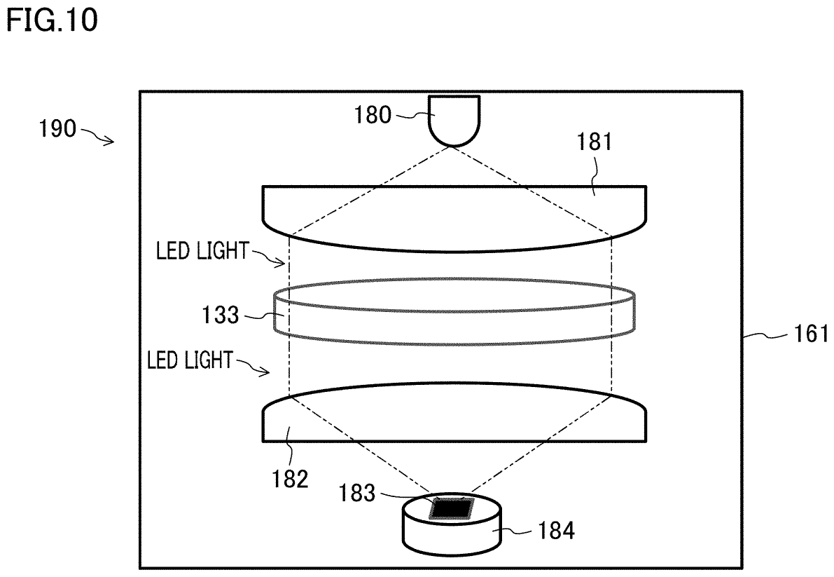

FIG. 9 illustrates a schematic sectional view of a laser light emission head according to the present embodiment, and FIG. 10 illustrates a schematic view of an internal configuration of an evaluation unit. Note that in FIGS. 9 and 10, the same reference numerals are used to represent elements similar to those of the first and second embodiments including the first and second variations, and detailed description thereof will be omitted.

The configuration described in the present embodiment and the configurations described in the first and second embodiments including the first and second variations are different from each other in the following points.

First, the evaluation unit 190 having a third housing 161 is, instead of the second cleaning unit 160 described in the second embodiment, provided in contact with a laser light shaping unit 110 and a cleaning unit 150. In the third housing 161, an LED light source 180 and a light receiving element 183 arranged with a predetermined spacing from the LED light source 180 in an upper-lower direction are arranged. That is, as illustrated in FIG. 10, the evaluation unit 190 is equivalent to a configuration excluding the partition wall 171 and the cleaning mechanism 155 from the cleaning unit 150 illustrated in FIG. 8.

A second housing 151 and the third housing 161 share a second partition wall 162, and a second slit 163 causing the cleaning unit 150 and the evaluation unit 190 to communicate with each other is provided at the second partition wall 162. A glass holder 130 is integrally rotatably coupled to a rotary shaft 116, and is configured movably among the laser light shaping unit 110, the cleaning unit 150, and the evaluation unit 190 through the first and second slits 114, 163. Moreover, three protection glasses 131 to 133 are attached to the glass holder 130.

LED light emitted from an LED light source 180 penetrates the protection glass 133 arranged in the evaluation unit 190, and based on a light reception signal received by a light receiving element 183, the transmittance of the protection glass 133 arranged in the evaluation unit 190, i.e., the degree of contamination, can be evaluated.

The laser light emission head 100 may be configured as described above. According to the present embodiment, a cleaning mechanism 155 can be arranged in a unit different from that for the LED light source 180 and the light receiving element 183 as compared to the configuration described in the second embodiment. Thus, there is no probability that a washing solution, metal scraps after cleaning, etc. adhere to a condensing lens 182 etc., and the degree of contamination on the protection glasses 131 to 133 can be evaluated with favorable accuracy over a long period of time, for example.

Three protection glasses 131 to 133 are attached to the glass holder 130, and are sequentially used for laser processing. Thus, even if one of these protection glasses needs to be replaced due to, e.g., burn, the remaining two protection glasses are sequentially cleaned and used in a predetermined cycle, and therefore, the cycle of replacing the protection glass can be more extended as compared to the configuration described in the first embodiment, for example. With this configuration, downtime of the laser light emission head 100 and a laser processing apparatus 1000 can be reduced, and an increase in an operation cost can be suppressed.

### Other Embodiments

In the configurations described in the first to third embodiments including the first and second variations, a lock mechanism (not shown) configured to lock the glass holder 130 such that the glass holder 130 is fixed at a predetermined position after having been moved is preferably provided in the laser light emission head 100.

Another mechanism may be used instead of the first to third opening/closing doors 120 to 122. It may only be required that the mechanism normally closes the first and second slits 114, 163 and is in an open state for moving the glass holder 130. For example, a shutter mechanism configured to move in parallel with side surfaces of the first and second partition walls 113, 162 may be provided instead.

Instead of the LED light source 180, another light source such as a lamp light source may be used. A photodiode or a photodiode array may be used as the light receiving element 183.

The laser light emission head of the present disclosure can eliminate the process of replacing the protection glass and reduce the apparatus downtime, and therefore, is useful in application to the laser processing apparatus.

### DESCRIPTION OF REFERENCE CHARACTERS

100 Laser Light Emission Head
110 Laser Light Shaping Unit
111 First Housing
113 First Partition Wall
114 First Slit
116 Rotary Shaft
120 to 122 First to Third Opening/Closing Door
130 Glass Holder
131 to 133 Protection Glass
140 Optical Component
150 Cleaning Unit
151 Second Housing
152 Washing Solution Supply Nozzle
154 Brushing Mechanism
155 Cleaning Mechanism
160 Second Cleaning Unit
161 Third Housing
162 Second Partition Wall
163 Second Slit
180 LED Light Source
183 Light Receiving Element (Light Receiving Portion) 190 Evaluation Unit 1000 Laser Processing Apparatus

What is claimed is:

1. A laser light emission head comprising:
a laser light shaping unit including a first housing configured such that laser light enters an upper portion of the first housing and an optical component configured to shape the laser light into a desired shape is arranged in the first housing;
a glass holder to which multiple protection glasses are attached with a predetermined spacing; and
a cleaning unit having a second housing in which a cleaning mechanism for cleaning the protection glasses attached to the glass holder is arranged,
wherein the glass holder is configured movably between the first housing and the second housing.

2. The laser light emission head according to claim 1, wherein
the second housing and the first housing share a first partition wall,
a first slit causing the laser light shaping unit and the cleaning unit to communicate with each other is provided at the first partition wall, and
the glass holder is configured movably between the first housing and the second housing through the first slit.

3. The laser light emission head according to claim 2, wherein
the glass holder is integrally rotatably coupled to a rotary shaft provided at the first partition wall, and
the glass holder rotates a predetermined angle to move the protection glass arranged in the laser light shaping unit into the cleaning unit and move the protection glass arranged in the cleaning unit into the laser light shaping unit.

4. The laser light emission head according to claim 2, wherein
the glass holder is configured linearly movably through the first slit, and
the glass holder moves a predetermined distance to move the protection glass arranged in the laser light shaping unit into the cleaning unit.

5. The laser light emission head according to claim 1, wherein
a light source and a light receiving portion arranged with a predetermined spacing from the light source in an upper-lower direction are arranged in the second housing, and
light emitted from the light source penetrates the protection glass arranged in the cleaning unit, and based on a light reception signal received by the light receiving portion, a degree of contamination on the protection glass arranged in the cleaning unit is evaluable.

6. The laser light emission head according to claim 2, wherein
an evaluation unit including a third housing in which a light source and a light receiving portion arranged with a predetermined spacing from the light source in an upper-lower direction are arranged is further provided in contact with the laser light shaping unit and the cleaning unit,
the second housing and the third housing share a second partition wall, and a second slit causing the cleaning unit and the evaluation unit to communicate with each other is provided at the second partition wall,
the glass holder is configured movably among the laser light shaping unit, the cleaning unit, and the evaluation unit through the first slit and the second slit, and
light emitted from the light source penetrates the protection glass arranged in the evaluation unit, and based on a light reception signal received by the light receiving portion, a degree of contamination on the protection glass arranged in the evaluation unit is evaluable.

7. The laser light emission head according to claim 1, wherein
the cleaning mechanism includes a washing solution supply mechanism configured to apply a washing solution to a surface of the protection glass and a brushing mechanism configured to remove the contamination on the surface of the protection glass to which the washing solution adheres.

8. The laser light emission head according to claim 1, wherein
the cleaning mechanism is a gas supply mechanism for spraying predetermined gas onto the surface of the protection glass.

9. A laser processing apparatus at least comprising:
a laser oscillator configured to emit laser light; and
the laser light emission head according to claim 1, the laser light emission head being configured to receive the laser light to emit the laser light toward a workpiece.

10. A laser processing apparatus at least comprising:
a laser oscillator configured to emit laser light; and
the laser light emission head according to claim 2, the laser light emission head being configured to receive the laser light to emit the laser light toward a workpiece.

11. A laser processing apparatus at least comprising:
a laser oscillator configured to emit laser light; and
the laser light emission head according to claim 3, the laser light emission head being configured to receive the laser light to emit the laser light toward a workpiece.

12. A laser processing apparatus at least comprising:
a laser oscillator configured to emit laser light; and
the laser light emission head according to claim 4, the laser light emission head being configured to receive the laser light to emit the laser light toward a workpiece.

13. A laser processing apparatus at least comprising:
a laser oscillator configured to emit laser light; and
the laser light emission head according to claim 5, the laser light emission head being configured to receive the laser light to emit the laser light toward a workpiece.

14. A laser processing apparatus at least comprising:
a laser oscillator configured to emit laser light; and
the laser light emission head according to claim 6, the laser light emission head being configured to receive the laser light to emit the laser light toward a workpiece.

15. A laser processing apparatus at least comprising:
a laser oscillator configured to emit laser light; and
the laser light emission head according to claim 7, the laser light emission head being configured to receive the laser light to emit the laser light toward a workpiece.

16. A laser processing apparatus at least comprising:
a laser oscillator configured to emit laser light; and
the laser light emission head according to claim 8, the laser light emission head being configured to receive the laser light to emit the laser light toward a workpiece.
